(19) United States
(12) Patent Application Publication
(10) Pub. No.: US 2022/0267011 A1
(43) Pub. Date: Aug. 25, 2022

(54) Airplane Seat Pillow Device

(71) Applicant: Ron Johnson, Grand Junction, CO (US)

(72) Inventor: Ron Johnson, Grand Junction, CO (US)

(21) Appl. No.: 17/668,047

(22) Filed: Feb. 9, 2022

Related U.S. Application Data
(60) Provisional application No. 63/147,298, filed on Feb. 9, 2021.

(51) Int. Cl. B64D 11/06

(52) U.S. Cl. CPC B64D 11/0642

(57) ABSTRACT

An airplane seat pillow device is described. Embodiments of the airplane seat pillow device can be implemented to provide a pillow proximate a head of a user. The pillow device can be configured to be placed between adjacent seats on an airplane seat. A pillow engagement member can be provided that can move in and out of a main body of the pillow device. At least one pillow can be removably secured to the pillow engagement member.

### CROSS-REFERENCE TO RELATED APPLICATION

This application claims the benefit of U.S. Provisional Application No. 63/147,298, filed Feb. 9, 2021.

### BACKGROUND

With airplane seats getting smaller and more compact, resting during flights is getting harder and harder. Inflatable pillows and neck pillows are currently available to aid in resting during flights. However, both have drawbacks. An inflatable pillow needs to be inflated by the user and then a place to rest the pillow needs to be found. This can lead to weird sleeping positions for the user. Neck pillows cure some of the deficiencies of inflatable pillows, however, there are drawbacks to neck pillows as well. A user is limited to how they can be positioned to use the neck pillow and generally, the neck pillow does not support an entire head of the user.

Further, customers are being brought in closer proximity to customers seated next to them as airplane seats continue to get narrower. As such, a sense of privacy is being reduced.

A device configured to place a pillow proximate a head of a user and provide some privacy for the user is needed.

### BRIEF DESCRIPTION OF THE DRAWINGS

FIG. 1 is a front perspective view of a pillow device in an extended configuration according to one embodiment of the present invention.

FIG. 2 is a front perspective view of a pillow device in a compact configuration according to one embodiment of the present invention.

FIG. 3 is an exploded view of a pillow device according to one embodiment of the present invention.

FIG. 4 is a front perspective view of a pillow device in an extended configuration according to one embodiment of the present invention.

FIG. 5 is a front perspective view of a pillow device in a compact configuration according to one embodiment of the present invention.

FIG. 6 is a front view of a pillow device according to one embodiment of the present invention.

FIG. 7 is a back view of a pillow device according to one embodiment of the present invention.

### DETAILED DESCRIPTION

Embodiments of the present invention include an airplane seat pillow device. The airplane seat pillow device can be configured to fit between two seats on an airplane and provide a pillow proximate a head of a user. The device can include strips of hook and loop fastening material to removably mate a pillow to the device. In one embodiment, the airplane seat pillow device can include a retractable member for securing a pillow thereto. In another embodiment, the airplane seat pillow device can include a protrusion extending from a main body of the device for securing the pillow thereto. Of note, embodiments are contemplated where a pillow is more permanently coupled to the pillow device. In some instances, an inflatable pillow can be implemented to reduce an overall size of the pillow device when not in use.

In one embodiment, a pillow device can include a main body having protrusions (e.g., guide members) for engaging a pair of airplane seats, a pillow engagement member, and at least one pillow. The main body can be configured to slide between adjacent seats on an airplane with the guide members engaging a front and back of the seat. Of note, the guide members can help prevent the pillow device from moving forwards (or backwards) when engaged with the seat. The pillow engagement member can extend out perpendicular in relation to a width of the seat. Since a gap between back rests of the airplane seats generally reduces from a top to a bottom of the seat, the main body can include the protrusions extending out perpendicularly from a longitudinal axis of the main body. Typically, the main body can include two pairs of protrusions that extend in opposite directions perpendicular to the longitudinal axis. In one instance, the protrusions can taper such that the protrusions engage the back rests substantially uniformly along a height of the protrusions.

The pillow device can be configured to be inserted between a pair of airplane seats. A pillow can be attached to the pillow engagement member extending out from the seats. Typically, the pillow can have a right triangular cross-section to provide an angled surface to a user when secured to the pillow engagement member. A back side of the pillow can include a patch of hook and loop fastener material to couple to the pillow engagement member. Of significant note, the pillow device can be removably inserted between a pair of airplane seats. Where two users know each other, a pillow can be attached to either side of the pillow engagement member such that each user can have a resting surface.

In a typical implementation, the user can rest their head on the pillow to allow for a natural upright position of the head while trying to sleep (or rest) on an airplane. As can be appreciated, this can allow a user to sit in the seat and rest their head on the pillow in a natural position. Since users may have differing heights, the pillow device can be configured to secure to the seats at different heights of the seats. For taller users, the pillow device may be less secure further up between the seats, however, as the taller user puts their head against the pillow, the pillow device can be secured between the seats. Embodiments are contemplated where a distance between the protrusions of the pillow device may be moved in and out to account for seats having different distances between themselves. For example, airplanes of different sizes can have seats closer or further apart.

The pillow engagement member can extend out from the seat and can include a plurality of strips of hook and loop fastener material (e.g., VELCRO®). The hook and loop fastener material can be implemented to removably couple the pillow to the pillow device. As can be appreciated, this can allow a user to remove the pillow when not in use to help keep the pillow clean. The plurality of hook and loop fastener material can be included on both sides of the pillow engagement member. As can be appreciated, a first pillow may be attached to one side of the pillow engagement member and a second pillow may be attached to the other side of the pillow engagement member.

In another embodiment, a pillow device can be similar to the first embodiment pillow device but may include a retractable pillow engagement member that may be retracted to shorten an overall length of the pillow device when not in use. For instance, the second embodiment airplane seat pillow device can include, but is not limited to, a main body, a pillow engagement assembly, and at least one pillow. The main body can have a substantially trapezoidal shape.

In a typical implementation, the second embodiment pillow device can first be wedged between a pair of seats on an airplane. After the device is in place, a pillow engagement member can be slid out from the pillow engagement assembly. The pillow engagement assembly can be housed in the main body. Once the pillow engagement member is extended, the at least one pillow can be coupled to the pillow engagement member and the pillow device can be ready for use by a user.

Generally, the second embodiment pillow device can include a retracted (or compact) configuration and an extended (or in-use) configuration. When in the retracted configuration, the pillow engagement member can be in retracted into the pillow engagement assembly to allow for a more compact device during non-use. The main body can include a patch of hook and loop fastener material on a top and a bottom of the device to store pillows when not in use. The pillow device can be tapered between two laterally extending protrusions of the main body.

In the extended configuration, the pillow engagement member can be extended out from the main body of the pillow device to provide a surface for a pillow to attach thereto. The pillow engagement member can include a plurality of strips of hook and loop fastener material to provide a means to mate with a pillow. Of note, both sides of the pillow engagement member can include the hook and loop fastener material.

As previously mentioned, the pillow device can include patches of hook and loop fastener material on a top and bottom of the main body to attach pillows thereto. As can be appreciated, the pillows can be secured to the pillow device when in use and when not in use. The pillows can typically have a right-triangular shape. Typically, a back side of the pillow can include a patch of hook and loop fastener material adapted to mate with the hook and loop fastener material on the pillow device or the pillow engagement member.

In one instance, the second embodiment pillow device can include, but is not limited to, a main body, a pillow engagement assembly, and one or more pillows. The main body can have a substantially trapezoidal shape and can include two pairs of guide members. A pair of guide members can be located on either side of the main body and can extend out in opposite directions.

The pillow engagement assembly can include a rigid housing and a pillow engagement member that can move in and out of the rigid housing. The main body and the pillow engagement assembly can each include a plurality of hook and loop fastener strips and/or patches. In one example, the main body can be made from a rigid (or semi-rigid) foam and can include guide members on either side to interface with airplane seats. It is to be appreciated that the main body, the rigid housing, and the pillow engagement member can be made from the same material and/or different materials. Generally, the pillow engagement member can be rigid. In some instances, the pillow engagement member may be manufactured from a semi-rigid material.

The rigid housing can be located inside the main body and can be configured to slidably receive the pillow engagement member. The rigid housing can include lateral extending members that mate with an interior of the guide members of the main body. The pillow engagement member can be configured to slide in and out of the rigid housing. The pillow engagement member can include the plurality of hook and loop fastener strips to secure the one or more pillows thereto. The pillows can include a patch of hook and loop fastener to removably couple to the hook and loop fastener strips of the pillow engagement member. In some embodiments, the pillows may be manufactured with a fabric that can mate with the hook and loop fastener strips (or patches).

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of an Airplane Seat Pillow Device

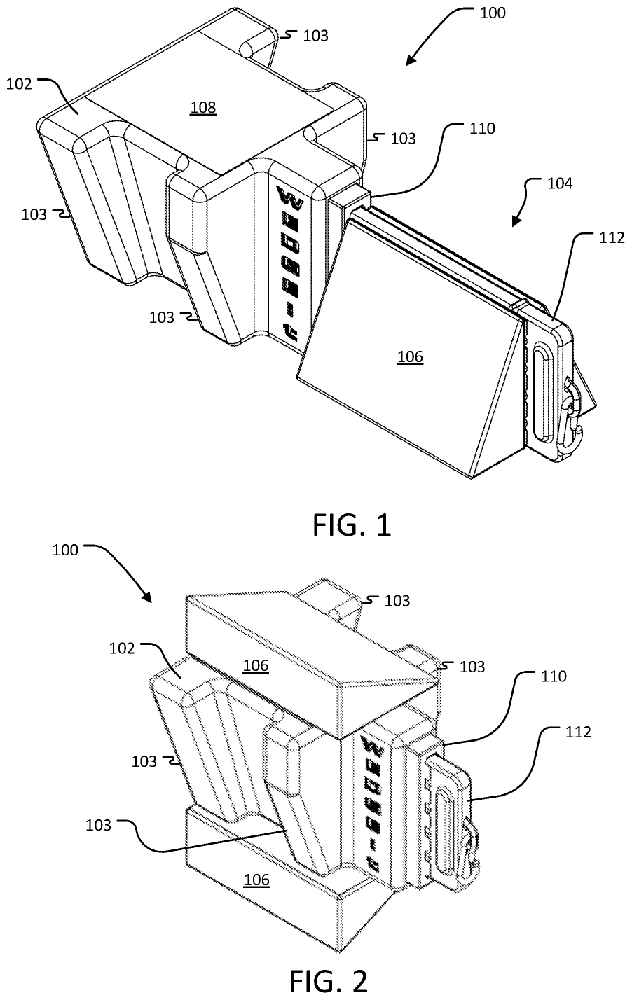

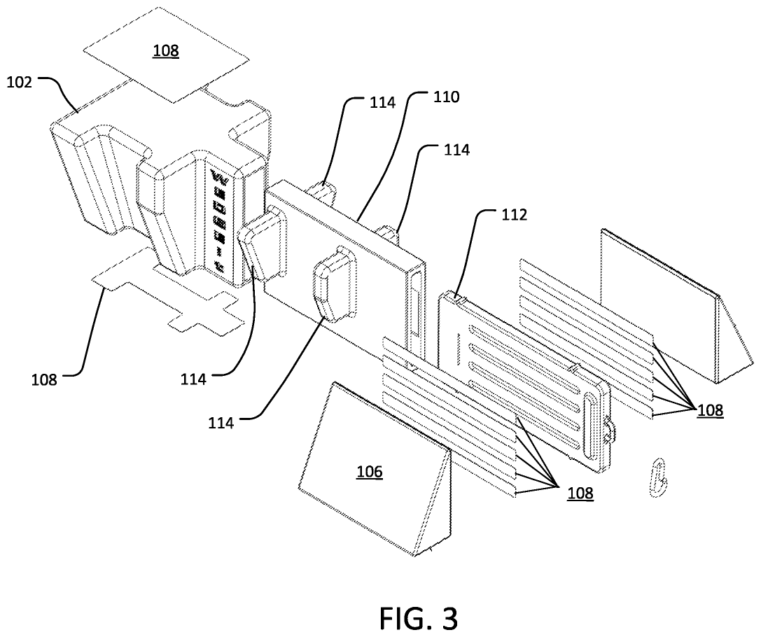

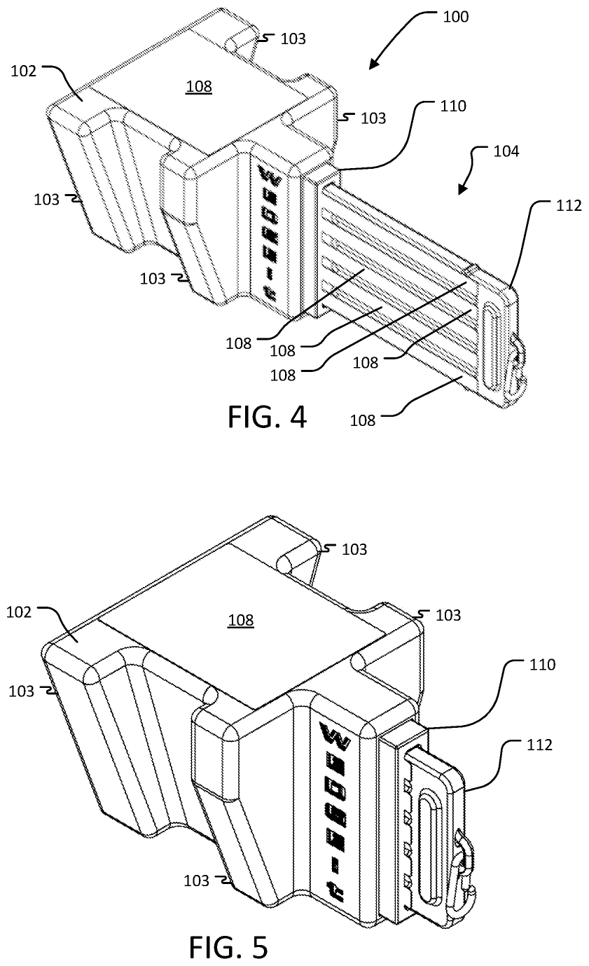

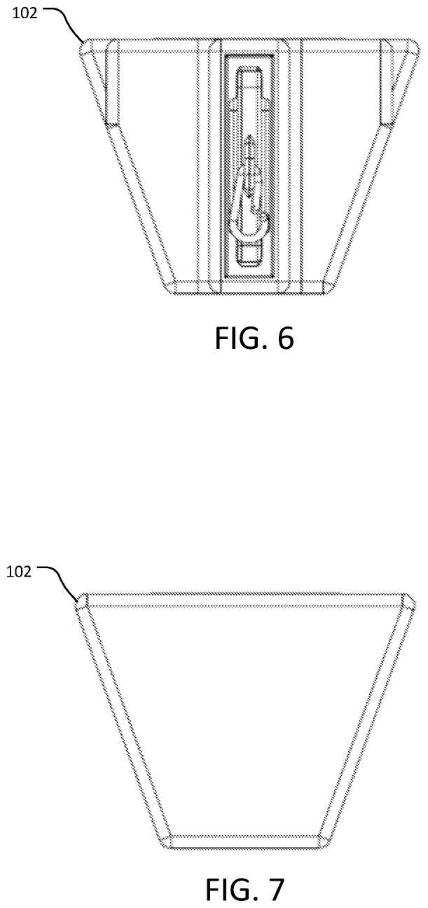

Referring to FIGS. 1-7, detailed diagrams of an embodiment 100 of a pillow device configured for an airplane seat is illustrated. The airplane seat pillow device 100 can be implemented to provide a pillow proximate a head of one or more users in an airplane. FIG. 1 shows the pillow device 100 in an extended configuration. FIG. 2 shows the pillow device 100 in a travel configuration. FIG. 3 is an exploded view of the pillow device 100. FIG. 4 shows the pillow device 100 in an extended configuration without pillows. FIG. 5 shows the pillow device 100 in a travel (or compact) configuration without pillows. FIG. 6 shows a front view of the pillow device 100. FIG. 7 shows a back view of the pillow device 100.

As generally shown in FIGS. 1-3, the pillow device 100 can include, but is not limited to, a main body 102, a pillow engagement assembly 104, and at least one pillow 106. The main body 102 can house a portion of the pillow engagement assembly 104 and can include one or more hook and loop fastener patches 108 for securing the at least one pillow 106 to the main body 102. The pillow device 100 can include the patches of hook and loop fastener material 108 on a top and a bottom of the main body 102 to store the at least one pillow 106 when not in use. The main body 102 and the pillow engagement assembly 104 can each include a plurality of the hook and loop fastener strips (and/or patches) 108.

In one embodiment, the main body 102 can have a substantially trapezoidal shape (as shown in FIGS. 6 and 7) and can be hollow to receive a portion of the pillow engagement assembly 104 therein. The main body 102 can include a plurality of guide members 103 adapted to interface with a seatback of an airplane seat. In one example, the main body 102 can be made from a rigid (or semi-rigid) foam. In another example, the main body 102 can be made from a rigid plastic. It is to be appreciated that other materials can be implemented without exceeding a scope of the present invention. With a substantially trapezoidal shape, the main body 102 can taper from a top to a bottom.

As generally shown in FIGS. 1-7, the plurality of guide members 103 can include a first pair of guide members extending in a first direction on a first side of the main body 102 and a second pair of guide members extending in a second, opposite direction from a second side of the main body 102. The plurality of guide members 103 can be implemented to interface with airplane seats. More specifically, a seatback of an airplane seat can be passed through the pair of guide members 103 such that the guide members 103 can prevent the main body 102 from moving forwards and/or backwards in relation to the seatback. In a typical implementation, the main body 102 can be placed proximate a top of two seatbacks and then lowered down with the seatbacks being located between respective guide members 103.

As shown generally in FIGS. 6 and 7, the main body 102 of the pillow device 100 can have a substantially trapezoidal shape. Of note, embodiments are contemplated where only a portion of the main body 102 located between the guide members 103 has a trapezoidal shape. The main body 102 can be oriented such that the base of the trapezoid can have a shorter length than a top of the trapezoid. The main body 102 can taper from a top surface to a bottom surface of the main body 102. As can be appreciated, this can allow the main body 102 to be wedged between adjacent seats on an airplane. In some instances, the guide members 103 of the main body 102 can be configured to taper.

Referring to FIGS. 2 and 4, the pillow device 100 is shown in a retracted (or compact) configuration. The pillow engagement member 112 can be retracted into the housing 110 to allow for a more compact device during non-use. As previously mentioned, the pillow engagement member 112 can be configured to slide in and out of the housing 110.

As generally shown in FIGS. 1-4, the pillow engagement assembly 104 can include, but is not limited to, a housing 110 and a pillow engagement member 112. The pillow engagement member 112 can be slidably coupled to the housing 110 such that the pillow engagement member 112 can move in and out of the housing 110. Generally, the housing 110 and the pillow engagement member 112 can each be manufactured from rigid materials. In some instances, the housing 110 and the pillow engagement member 112 may be manufactured from semi-rigid materials.

The rigid housing 110 can be located inside the main body 102 and can be configured to slidably receive the pillow engagement member 112. The rigid housing 110 can include lateral extending members 114 that mate with an interior of the guide members 103 of the main body 102. The pillow engagement member 112 can be configured to slide in and out of the rigid housing 110. The pillow engagement member 112 can include the plurality of hook and loop fastener strips 108 to secure the one or more pillows 106 thereto. The pillows 106 can include a patch of hook and loop fastener to removably couple to the hook and loop fastener strips of the pillow engagement member 112 and the main body 102. In some embodiments, the at least one pillow 106 may be manufactured with a fabric that can mate with the hook and loop fastener strips (or patches).

Referring to FIGS. 1 and 4, the pillow device is shown in an extended configuration. The extended configuration can be an in-use configuration where the pillow device 100 can be placed between two seatbacks on an airplane. Once the main body 102 is placed proximate a head height of the user, the pillow engagement member 112 can be slid out from the housing 110. The at least one pillow 106 can be secured to the pillow engagement member 112 and the user can have a pillow to rest on with the pillow being secured by the main body 102 to the seatbacks.

Referring to FIGS. 2 and 5, the pillow device 100 is shown in a retracted (or compact) configuration. The pillow engagement member 112 can be retracted into the housing 110 to allow for a more compact device during non-use. As previously mentioned, the pillow engagement member 112 can be configured to slide in and out of the housing 110.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

In one embodiment, the airplane seat pillow device can include a rigid pillow engagement member extending out from a main body. In one instance, the pillow engagement member can be coupled to the main body. A pillow can be adapted to be removably coupled to the pillow engagement member via hook and loop fastening material. The pillow engagement member can include hook and loop fastening material on either side such that a pillow can be attached to either side of the pillow engagement member. The main body can include two pairs of protrusions extending in opposite directions from the main body. The two pairs of protrusions can be configured to interface with airplane seats. In some embodiments, the main body can be tapered between each pair of protrusions. The airplane seat pillow device can be configured to provide a pillow proximate a head of a user when sitting in an airplane seat.

I claim:

1. A pillow device comprising:
a main body having a trapezoidal shape;
at least one pillow; and
a pillow engagement assembly, the pillow engagement assembly including:
a housing located substantially within the main body; and
a pillow engagement member slidably coupled to the housing.

2. The pillow device of claim 1, wherein in a first configuration (i) the pillow engagement member is located substantially within the housing, and (ii) the at least one pillow is secured to the main body.

3. The pillow device of claim 1, wherein in a second configuration (i) the pillow engagement member is located substantially outside of the housing, and (ii) the at least one pillow is secured to a first side of the pillow engagement member.

4. The pillow device of claim 1, wherein the main body includes a first pair of guide members extending laterally from a first side of the main body and a second pair of guide members extending laterally from a second side of the main body.

5. The pillow device of claim 4, wherein the first pair of guide members extend in an opposite direction to the second pair of guide members.

6. The pillow device of claim 1, wherein the pillow engagement member has a substantially rectangular shape and includes a plurality of strips of hook and loop material.

7. The pillow device of claim 1, wherein the at least one pillow has a right triangular shape.

8. The pillow device of claim 1, wherein the main body includes a patch of hook and loop material for coupling the at least one pillow thereto.

9. The pillow device of claim 1, wherein the pillow engagement member is adapted to slide in and out of the housing.

10. The pillow device of claim 1, wherein pillow engagement member is rigid.

11. A pillow device for an airplane, the pillow device comprising:
a main body having a trapezoidal shape, the main body being defined by:
a first pair of guide members extending laterally from the main body in a first direction; and
a second pair of guide members extending laterally from the main body in a second and opposite direction to the first direction;
at least one pillow; and
a pillow engagement assembly, the pillow engagement assembly including:
a housing, the housing being located substantially within the main body; and
a pillow engagement member slidably coupled to the housing.

12. The pillow device of claim 11, the pillow device further including a second pillow.

13. The pillow device of claim 11, wherein the main body includes a patch of hook and loop material for the at least one pillow to secure to.

14. The pillow device of claim 11, wherein in a first configuration (i) the pillow engagement member is located substantially within the housing, and (ii) the at least one pillow is secured to the main body.

15. The pillow device of claim 11, wherein in a second configuration (i) the pillow engagement member is located substantially outside of the housing, and (ii) the at least one pillow is secured to a first side of the pillow engagement member.

16. The pillow device of claim 11, wherein the main body of the pillow device is configured to be wedged between a pair of airplane seats.

17. The pillow device of claim 11, wherein the pillow engagement member includes a plurality of strips of hook and loop material.

18. The pillow device of claim 11, wherein the at least one pillow has a substantially right triangular shape.

19. The pillow device of claim 11, wherein the main body is hollow.

20. A pillow device for an airplane, the pillow device comprising:
a main body having a substantially trapezoidal shape, the main body being defined by:
a first pair of guide members extending laterally from a first side of the main body in a first direction; and
a second pair of guide members extending laterally from a second side of the main body in a second direction opposite to the first direction;
at least one pillow; and
a pillow engagement assembly including:
a housing located substantially within the main body; and
a pillow engagement member slidably coupled to the housing, the pillow engagement member including a plurality of strips of hook and loop material on either side of the pillow engagement member.
